(19) United States
(12) Patent Application Publication
(10) Pub. No.: US 2005/0097869 A1
(43) Pub. Date: May 12, 2005

(54) Waste gas purification structure with circulated filtering and coating

(76) Inventor: Chih-Chung Yu, Hsin Chu City (TW)

Correspondence Address: Chih-Chung Yu, P.O. BOX 7-820, Taipei, TW

(21) Appl. No.: 10/705,543

(22) Filed: Nov. 12, 2003

(51) Int. Cl. B01D 46/18

(52) U.S. Cl. 55/354

(57) ABSTRACT

The present invention discloses a cross-meshed waste gas purification structure with circulated filtering and coating that is comprised of a filter, a support axle, a bearing housing, a motive rod, a chest base, and a motor; wherein a bearing is pivotally coupled to each of both ends of the support axle, and the two bearing housings are disposed in the chest base with an appropriate distance apart, set at a different height with the bearing housing fixed on the opposite side of the housing, such that each of both sides has a support axle with different heights with each other to allow a S-shaped filter to move along and facilitate the filter to be fixed to the intersection of both sides for collecting paint and dust. The meshes on both sides of the S-shaped track circulation completely stick the dust or residue into the aperture to increase the storage area, and thus accomplishing a complete purification function and attaining the practical effect of purifying the air by the meshed cross circulation on both sides. The waste gas purification structure in accordance with this invention can be disposed and incinerated after its use without the need of cleansing the tank that may pollute the water source. The present invention is definitely a pioneering work for industrial waste gas treatment.

### BACKGROUND OF THE INVENTION

Nowadays, factories such as ironware casting factories, gilding factories, or painting factories, etc. use different substances according to their operating nature. Those substances then generate magnetic dust from various kinds of chemical elements. If the dust is inhaled, it will cause lung diseases that may further become the cause for any myocardium disease to human bodies, and it may cause lung cancer or other physiological and pathological changes if workers work in such an environment for a long time. It is indeed a potential life threat to workers. Any worker who is aware of such hazardous conditions will be reluctant to work in such environment for the sake of health. Further, the polluted air generated in factories not only is a potential life threat to physical conditions of workers but also to that of the public in whole. Particularly, if a pregnant woman inhales such polluted air for a long time, it will endanger the life of the next generation. Please note that the current masks available are commonly made of cotton and are insufficient to safeguard us from the seriously polluted dust. In view of such shortcoming, the inventor discloses this invention-WASTE GAS PURIFICATION STRUCTURE.

### SUMMARY OF THE INVENTION

The primary objective of the invention is to provide a cross-meshed waste gas purification structure with circulated filtering and coating, especially via the compositions of a filter, a support axle, a bearing housing, a motive rod, a chest base, and a motor to achieve the practical use of cross meshes by circulating both sides for air purifying.

The secondary objective of the present invention is to provide a cross-meshed waste gas purification structure with circulated filtering and coating, wherein a bearing is pivotally coupled to both ends of the support axle and both bearing housings are disposed equidistantly apart in the chest base set at an appropriate distance with the bearing housing fixed on the opposite side of the housing.

Another objective of the present invention is to provide a cross-meshed waste gas purification structure with circulated filtering and coating, wherein each of both sides has support axles cross one another to allow a S-shaped filter to move along and facilitate the filter to be fixed to the intersection of both sides for collecting paint and dust.

Another further objective of the present invention is to provide a cross-meshed waste gas purification structure with circulated filtering and coating, wherein the meshes on both sides of the S-shaped track circulation are used to completely stick the dust or residue into the aperture to increase the storage area, and thus accomplishing a complete purification function.

### BRIEF DESCRIPTION OF THE DRAWINGS

FIG. 1 is an illustrative diagram of the structure composition of the present invention;

FIG. 2 is a perspective diagram of the structure components of the present invention;

FIG. 3 is an illustrative diagram of the preferred embodiment of the present invention;

FIG. 4 is an illustrative diagram of the structure according to the present invention when it sticks out the dust;

FIG. 5 is an illustrative diagram of the curved cross circulation function of the present invention; and

FIG. 6 is an illustrative diagram of the preferred embodiment of mesh picking up and cleaning the dirty paint or residues of the present invention.

### DELTAILED DESCRIPTION OF THE PREFERRED EMBODIMENT

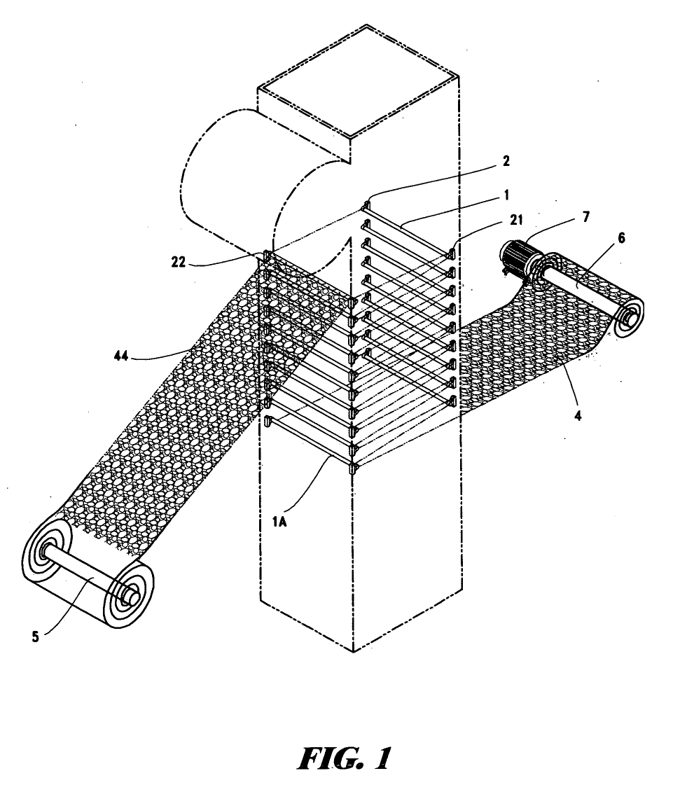

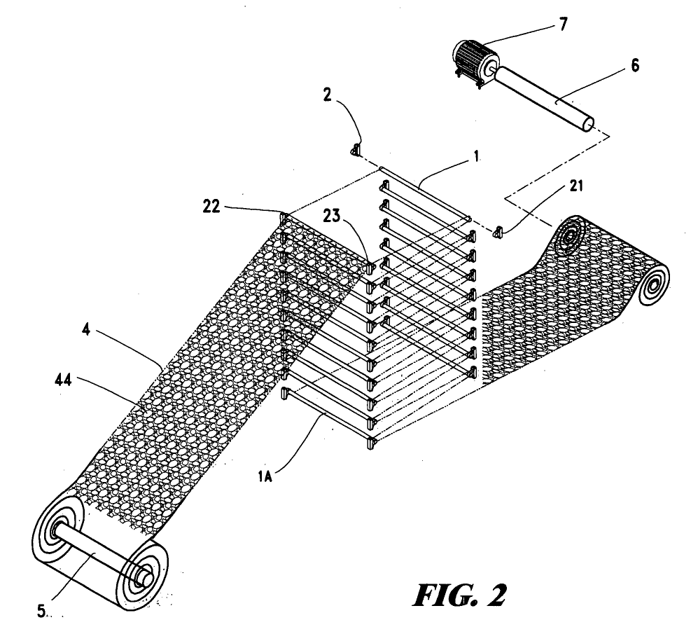

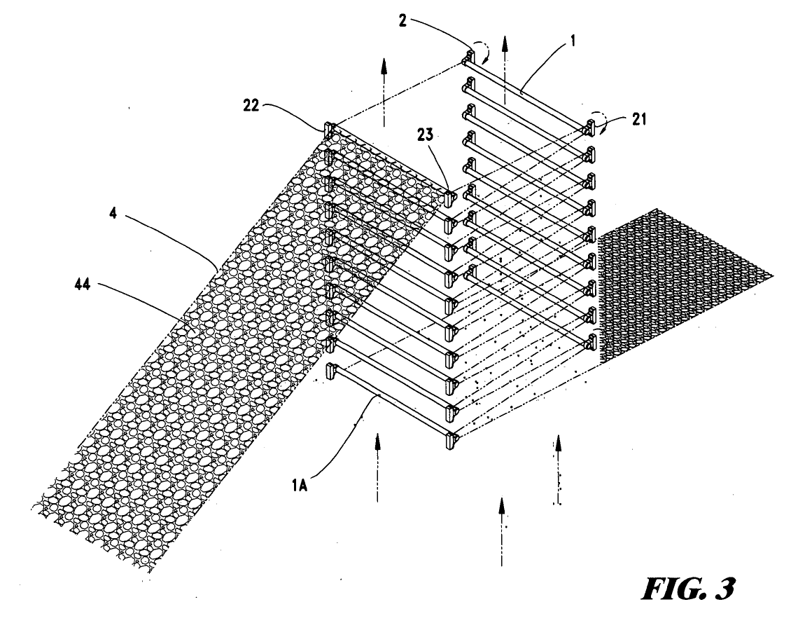

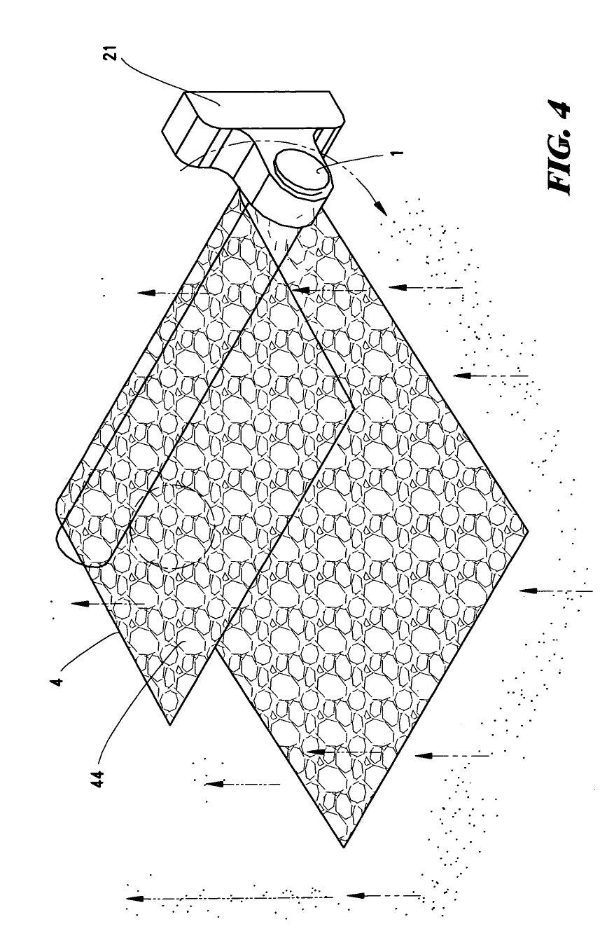

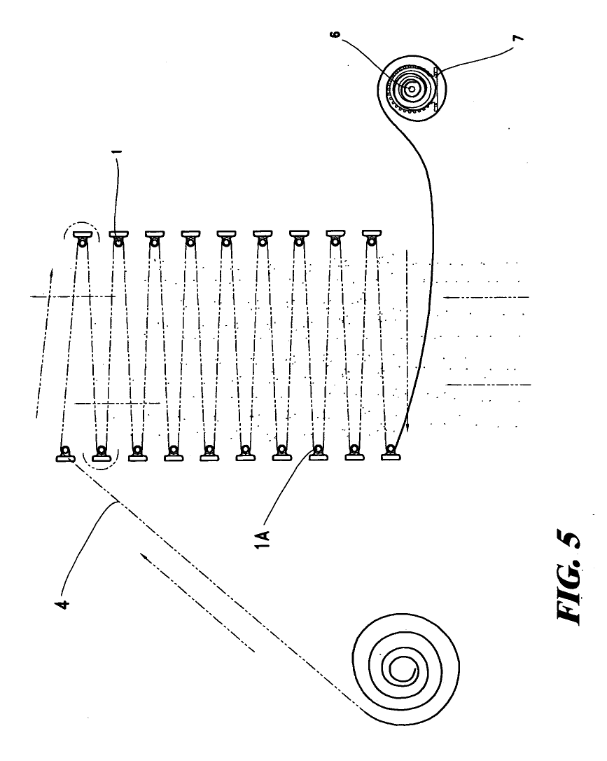

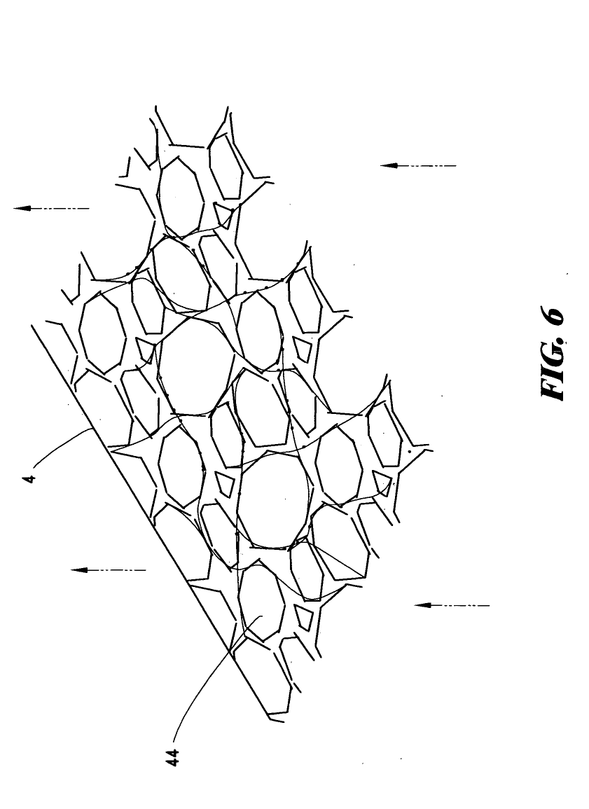

Please refer to FIGS. 1 to 6 for a cross-meshed waste gas purification structure with circulated filtering and coating that is comprised of a filter, a support axle, a bearing housing, a motive rod, a chest base, and a motor; wherein a bearing house 2, 21 is pivotally coupled to each of both ends of the support axle 1, and assembled into two axial holes, and the two bearing housings are disposed in the chest base with an appropriate distance apart. A bearing housing 2, 21 is pivotally coupled to each of both spherical ends of the support axle 1, and assembled into the two axial holes to set the two bearing housings with an appropriate distance at the two opposite ends of the inner walls of the chest base and aligned in rows in the cross-section, and a bearing housing 22, 23 each is fixed on the opposite walls to form relatively high and low position, such that the two parallel support axles 1, 1A are disposed alternately in the vertical direction to let the filter 3 pass through the S-curve state driving. The filter is made of interwoven cotton meshed member, and meshes 44 are spread all over the meshed surface, and supported by one end of a rotary rod 5. The filter passes from the top of the chest base through a first axle back and forth into the bottom of the bidirectional support axle for discharging the output at a motive rod 6. The motive rod is coupled to a variable motor 7 for driving the rod to rotate 360° and roll the filter upward to define a multi-layer S-shape route in order to facilitate the accommodate the filter plate such that it can move back and forth within the two surface and the intersection makes the dirty paint be mixed up with the waste gas. By means of both surfaces having meshes along the S-curved track, the tiny residue or paint will be adhered into the tiny apertures to increase the storage area and give a 100% purified air function. The cross circulation of the two meshed surfaces is used to purify air definitely has its practical effect. However, this filter is not limited to cotton woven mesh member, but any mesh plate having meshes capable of adhering dirty paint can also be used to eliminate waste gas and filter the pollutant.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

1. A cross-meshed waste gas purification structure with circulated filtering and coating that is comprised a filter, a support axle, a bearing housing, a motive rod, a chest base, and a motor; wherein a bearing being pivotally coupled to each of both ends of said support axle, and said two bearing housings being disposed in parallel at the opposite ends of the inner walls of said chest base with an appropriate distance apart and setting a different height with the bearing housing fixed on the opposite side, such that each of both sides having a support axle with different heights with each other to allow a S-shaped filter to move along and facilitate the filter to be fixed to the intersection of both sides for collecting paint and dust, and said filter being an interwoven cotton mesh member with meshes all over its meshed surface, and being supported by a rotary rod at one end, and said filter passing through a first support axle back and forth into two support axle at the bottom and output from a motive rod, and the motive rod being coupled to a variable motor for driving said filter upward to define a multi-layer S-shaped track for the movement, such that both sides being capable of mixing the dirty paint with the waste gas to accomplish the air purification function.

2. A cross-meshed waste gas purification structure with circulated filtering and coating that is described in 1^{st} item of Patent Application, wherein said meshes on both side of the S-shaped track adhere the dirty residue into the apertures of said meshes to increase the storage area and accomplish a 100% purification function.
